(19) United States
(12) Patent Application Publication
(10) Pub. No.: US 2022/0343222 A1
(43) Pub. Date: Oct. 27, 2022

(54) KROOZ Apps Features

(71) Applicant: Godwin E. Enogieru, Dallas, TX (US)

(72) Inventor: Godwin E. Enogieru, Dallas, TX (US)

(21) Appl. No.: 17/239,149

(22) Filed: Apr. 23, 2021

(51) Int. Cl. G06Q 10/02; G06Q 30/02; G06Q 50/30; G06Q 50/00; H04W 4/02

(52) U.S. Cl. CPC G06Q 10/02; G06Q 30/0282; G06Q 50/30; G06Q 50/01; H04W 4/025

(57) ABSTRACT

The present invention is a novel and improved system and method for apps features that are improving both drivers and riders experience on the road. With the app customers can request RIDE and DELIVERY service through mobile app. And riders can experience exciting features such as: Stop & Wait, TAG, SOS panic button, rate driver with our stylish meter rating system, also unique friends, and family follow feature, get notified when a rider board or arrived destination.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to embodiments described herein pertain generally to a system and method for arranging transport amongst parties through use of mobile devices with features such as stop & wait, safe and security notification system, tag favorite drivers, SOS family & friends in-case of distress and meter style driver rating.

### DESCRIPTION OF THE RELATED ART

Transportation is fundamental to modern lifestyles throughout the world. The size and population of modern cities often makes the identification of reliable transportation, whether such transportation is of people or goods, a difficult and unreliable task.

Practical methods used for hiring taxis and couriers changed little throughout the 20th century and remain un-optimized given the advent of technology. Current methods rely on the rider having knowledge of available options. Due to the lack of interlinks among users and providers, this necessarily results in a hirer having limited (and, therefore, frequently non-ideal) options. Having limited options means that a user is often forced to settle for a provider that is unsafe, untimely, too expensive, or a combination thereof.

Travelers are bypassing the taxi queue with greater frequency, choosing instead ride-sharing services like Lyft or Uber. While taxis, limousines and airport shuttles still dominate the ground transportation business, ride-sharing services are rapidly on the rise among business travelers.

However, to Applicant's knowledge, none of these prior art methods have been found to be completely suitable to meet these needs and are cumbersome. The present invention provides such a method, and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as whole.

In order to solve the above problems, the present invention relates to a peer-to-peer ride sharing transportation dedicated to providing suitable, alternatively comfortable, and reliable rider service via mobile apps which allows customers with smart-phones to book a ride request from any desired location, then routed to the app network with independent partner drivers who uses their own cars, picked up the rider and drive the rider to his or her destination.

The app has properties through which riders can experience exciting features such as: Stop & Wait, TAG, SOS panic button, rate driver with a unique meter rating system, also unique friends and family follow feature, get notified when a rider board or arrived destination.

The present invention provides for a novel and improved ride-sharing vehicle includes a mobile device to receive a ride-sharing request from a rider, wherein the mobile device retrieves a social network profile from the rider and identifies one or more interests from the rider.

According to yet another embodiment, the present invention provides methods for riders and drivers to a favorites list/folder on the App. If the driver is not available, riders can then choose other drivers on their favorites lists or choose any available drivers that is in the area that are not on their favorites list.

Another embodiment of the present invention is App that feature display on customer app for emergency and safety purpose, and on driver app, a feature that can be pushed, and the system will initiate a 911 number and the 911 is called in case of emergency should they be any problem during the ride.

Yet still another object of the system consists of several modules which can be combined in numerous ways, and which are variously designed to operate on computers, mobile devices, other electronic devices that may become available in the future, on private networks, and on servers reached through browsers or other means.

With the TAG Favorite Driver unique feature customers or rider can easily tag a driver he or she deemed as a favorite driver. When the TAG is generated on the customer app it will trigger the driver app back-end functionality and whenever a ride request is generated by the customer, the driver that is being tagged by that customer/rider will receive the ride request first as priority.

It is therefore an object of the present invention to provide such a system which makes things convenient. Also, the app helps transmitting means and for producing differentiable distress signals for emergency and security purpose the said feature enable the riders to add contacts from their phone as ride request is generated, and SMS notification is sent to the contact when the rider board or arrive destination.

With the app the drivers can accept both RIDE and DELIVERY from delivering Small Parcels & Packages—Auto parts, Flowers, Gift's basket, Medical supplies, and or Office-to-Office express delivery to Catering & Fast-food delivery.

Numerous other embodiments are also possible.

The app system improves utilization of a car, which sits idle costing owners loan/lease payments, maintenance, parking, and insurance. The system turns an underutilized, expensive possession into an asset that has a real economic and environmental impact in the community.

This Summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 100 is a schematic illustration of the app design.

FIG. 200 shows another view once the ride is requested.

FIG. 300 shows stop and wait timer.

FIG. 400 shows the rating view of the app.

FIG. 500 shows app requesting ride or delivery option.

FIG. 600 shows the option on the app to request ride or delivery.

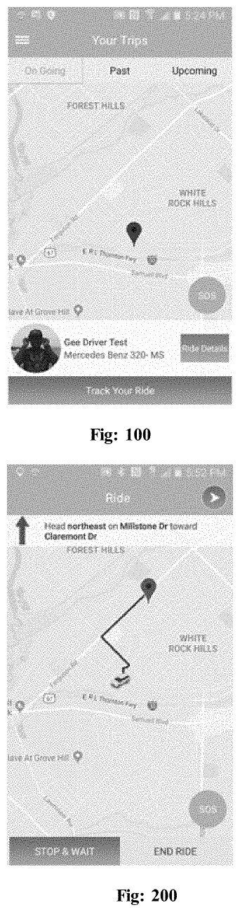

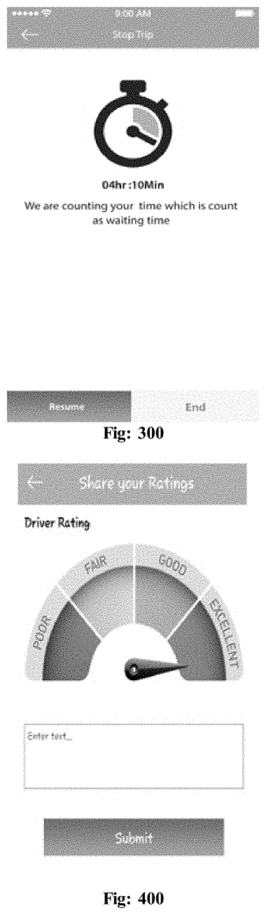

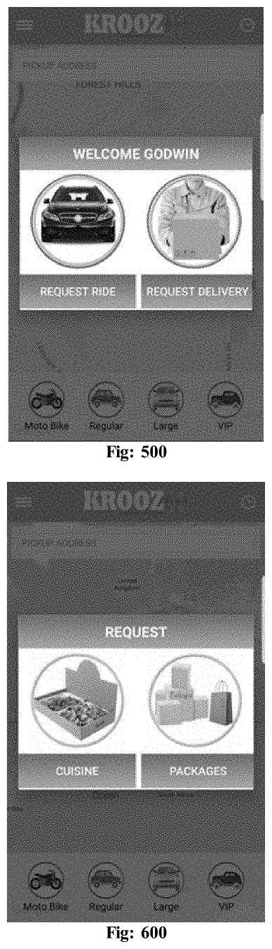

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting unless the claims expressly state otherwise.

An application of the present invention relates to riders can experience exciting features such as: Stop & Wait, TAG, SOS panic button, rate driver with our stylish meter rating system, also unique friends, and family follow feature, get notified when a rider board or arrived destination.

This app can be used by customers so drivers can pick up and deliver, example: Small Parcels & Packages—Auto parts, Flowers, Gift's basket, Medical supplies, and or Office-to-Office express delivery; Catering & Fast-food delivery.

The process of the app is, a feature that can be pushed, and the system will initiate a 911 number and the 911 is called in case of emergency should they be any problem during the ride.

Another embodiment of the invention is that the driver has the ability to click on a “Stop & Wait” button built on our driver apps. If a rider asked the driver to stop during the ride for any reason, example to stop and buy something on the way or so, and while the driver wait for the customer during the ride the rider will be charged for the driver WAIT time. This unique feature is located on the driver app.

### How the Stop & Wait Features Works:

When a customer asked the driver to stop during the trip, driver will activate the STOP & WAIT button located on the Driver app. When the Stop & Wait button is activated, a digital clock displayed on the driver's app screen will start counting minutes until the STOP & Wait is deactivated. When the STOP & WAIT is deactivated a sub-total amount of the wait time based on the preset Stop & Wait amount on the platform is added to the total amount of the customer ride fare. The Stop & Wait enable Drivers to earn extra money while they wait for customer at any time during the ride, and also gives our customer the flexibility of enjoying the ride share service.

Safe Ride

Another security feature is to ensure that riders always enter the right car this ensures enhance protection of the rider.
How the SAFE RIDE feature works:
When a rider request and ride, the driver accept the ride. When the driver arrived the customer pickup location. A notification is sent to the rider that the driver has arrived, the notification will include a numeric security code number example XXX XXX. That security code number example: XXX XXX received by the rider. Now when the driver picks up the customer or rider. The rider must give the security code number XXX XXX received to the driver. So, the driver will need to enter that code into his app before able to START THE RIDE. When the driver clicks START RIDE, the system will prompt him to enter the rider security code number. Until the code is entered the ride won't start. And when the code is entered accurately the ride will start and the message MATCHED will be displayed on both driver and rider app screen.

TAG

Another feature is TAG Favorite Driver unique feature in which customers or rider can easily tag a driver he or she deemed as a favorite driver. When the TAG is generated on the customer app it will trigger the driver app back-end functionality and whenever a ride request is generated by the customer, the driver that is being tagged by that customer/rider will receive the ride request first as priority. The TAG feature is dedicated to delivering their riders with the unique, most convenient, and rider-friendly feature ‘TAG’. Now, riders or customers can choose their favorite driver, TAG them, and the service request will be sent to the Tagged Drivers first when they use the App next time.

### How the Driver TAG Feature Works:

When the ride is complete, the customer/rider has the option in rating, reviewing the driver or TAG the driver through the customer apps.
When the rider/customer clicked to TAG a driver, the name and avatar of the driver will be added to the customer TAG LIST also, the driver that is being tagged will also see the customer who TAGGED him in his/her Tag list, so whenever the customer/rider decided to place order for ride or delivery request the previously tagged drivers will get the request as priority.

SOS

This security feature enables the rider, or the driver call 911 emergency number while the app is active should there be emergency that require urgent or law enforcement attention.

### How the SOS Feature Work:

In each ride, while the ride is active the SOS icon will display on the app screen both in customer and driver app, should they be any issue or emergency that require calling law enforcement or 911, the rider or the driver can click on the SOS icon displayed on the screen. When the SOS is clicked the 911 phone pad is launched automatically on the app screen, then the rider or driver can then click call button and the 911 emergency number is dialed immediately.

Friends and Family Follow

This security feature alert family members when a rider safely arrived destination.
How the Friends and Family Follow feature works:
When rider request for the ride and when the driver accepted the ride and going for pick up there is one screen where we show call driver and cancel ride, just down there is button with title “SEND STATUS” OR “ADD CONTACT”, when rider click it will show all the contacts of your mobile phone and you can add the contact number. Once you added the number in our Data base than its automatically send the status whenever ride is started, Stop and Wait initiated, and when ride is completed.

Meier Style Driver Rating:

Another unique creative design to enable our customer rate and review the driver respectively. The meter style feature is located on customer apps.

### How the Meter Style Driver Rating Feature Works:

The app created a stylish meter style driver rating system, which can easily be moved with fingertip from red color to green based on the rating the individual customer deemed or desired to give the driver with the text entitled poor, fair, good, excellent position.
The app interactive meter style rating system comprises of a moveable black arrow pointing to color green, light green, yellow, and red. Underneath which consist a text box that enable customer write a review before clicking on submit.

The system allows a rider to give some indication of his/her personality type/preference for a preferred level of interaction ensures that riders and drivers alike are more likely to have a positive experience on a given ride.

It is noted that the simplified diagrams and drawings do not illustrate all the various connections and assemblies of the various components, however, those skilled in the art will understand how to implement such connections and assemblies, based on the illustrated components, figures, and descriptions provided herein, using sound engineering judgment.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method of sharing location in connection with a request for service from a customer through a GPS- and web-enabled cell phone device, comprising.
a) A stop and wait feature to stop a trip during a journey.
b) A tag Favourite Driver feature to receive a ride request with a priority driver.
c) A rating driver feature to notify friends and family.

2. A GPS- and web-enabled cell phone device giving priority to the best riders.
